(19) United States
(12) Patent Application Publication
(10) Pub. No.: US 2015/0371265 A1
(43) Pub. Date: Dec. 24, 2015

(54) DIRECT MOBILE MARKETING BY REGISTERED LOCAL BUSINESS MEMBERS USING A SOCIAL NETWORK PLATFORM

(71) Applicant: Entice Us, Inc., San Diego, CA (US)

(72) Inventor: Jacob Michael Leisher, San Diego, CA (US)

(21) Appl. No.: 14/743,931

(22) Filed: Jun. 18, 2015

Related U.S. Application Data
(60) Provisional application No. 62/014,009, filed on Jun. 18, 2014.

(51) Int. Cl. G06Q 30/02; G06Q 50/00

(52) U.S. Cl. CPC G06Q 30/0257; G06Q 30/0261; G06Q 30/0267; G06Q 50/01; G06Q 30/0273

(57) ABSTRACT

Methods, systems, and devices are described for implementing an online social network platform designed for businesses (e.g., especially for retail businesses) to self-market directly to customers in real-time using the customer's geographical location (geo-location). The disclosed online social network platform provides the businesses with real-time marketing tools directly to previous customers and potentially new customers, including those local and visiting. In some implementations, the disclosed social network platform also provides business users with a business management platform connect to easily manage unique aspects of their business and connections with their customers using interactive user applications.

### CROSS REFERENCE TO RELATED APPLICATIONS

This patent document claims the benefits and priority of U.S. Provisional Patent Application No. 62/014,009, entitled “DIRECT MOBILE MARKETING BY REGISTERED LOCAL BUSINESS MEMBERS USING A SOCIAL NETWORK PLATFORM,” filed on Jun. 18, 2014. The entire content of the aforementioned patent application is incorporated by reference as part of the disclosure of this application.

### TECHNICAL FIELD

This patent document relates to systems, devices, and processes that use social media technologies for direct business marketing and mobile advertising.

### BACKGROUND

Social media can be used for facilitating interactions among people in which they create, share, or exchange information, contents and ideas, e.g., including shared interests, activities, backgrounds, or real-life connections, in virtual communities and networks, e.g., typically over an online social network. An online social network is a service, platform, or site using mobile and web-based technologies that generally focuses on social linkages and relations between individuals, groups, and/or organizations which form a social structure determined by their interactions, such as sharing, co-creation, and modification of user-generated content. A social network service can include a representation of each user (e.g., as a user profile), social links, and a variety of additional services. For example, user profiles can include photos, lists of interests, contact information, and other personal information. Online social network services are web-based and provide means for users to interact over the Internet, e.g., such as private or public messaging, e-mail, instant messaging, etc. Such social networking services allow users to share photos, ideas, activities, events, and interests within their personalized networks and publicly.

### SUMMARY

Techniques, systems, and devices are described for implementing an online social network platform designed for businesses (e.g., especially for retail businesses) to easily manage the unique aspects of their business and to self-market directly to customers using mobile computing devices (e.g., previous and potentially new customers, including local and visiting) in real-time using the customer's geographical location (geo-location) and engage connected customers with specific offerings.

In one aspect, a method to provide direct advertising in real-time includes receiving, at a computer system of one or more computers, advertisement information of an event or promotion from a business registered with a social network; producing, at the computer system, one or more current advertisements associated with the business based on the received advertisement information; receiving, at the computer system, location data from a mobile communications device of an individual user using a mobile application of the social network; analyzing, at the computer system, the received location data to determine a regional area of the individual user's location based on a range defined by the location data and a distance setting associated with the individual user; generating, at the computer system, a listing of businesses registered with the social network within the determined regional area; providing, by the computer system, an interactive user interface on the mobile application to present to the individual user at least one of a graphic or textual representation of the businesses on the generated listing; receiving, at the computer system, a request by the individual user for information of a selected business chosen by the individual user from the businesses presented on the interactive user interface; and providing, by the computer system, the produced one or more current advertisements associated with the selected business for display on the interactive user interface of the mobile application.

In one aspect, a method for determining payment for online posts to users of a social network includes receiving, at a computer system of one or more computers, subscription information and payment information and an account type from a business user for registering to join a social network; producing, at the computer system, an online profile of the registered business user capable for display on an interactive user interface of a web-based or mobile application of the social network; determining, at the computer system, an amount of information posts to make available to the registered business user for a particular time period based on the account type; receiving, at the computer system, business information of an event or promotion from the registered business user of the social network; producing, at the computer system, one or more information posts associated with the registered business user based on the received business information; providing, by the computer system, the produced one or more information posts on the interactive user interface of the web-based or mobile application to present to an individual user for display upon selection of the registered business user's online profile by the individual user; and determining, at the computer system, a payment value for the produced one or more information posts based on the determined amount of information posts and an amount of the information posts provided on the interactive user interface of the web-based or mobile application.

In one aspect, a system for providing an online social network platform includes a communication network including one or more computers in communication with a plurality of remote computing devices operated by business users and by consumer users of a social network via a communication network or link, in which the business users are users that operate a business and are registered to participate on the social network by a paid subscription, and consumer users are individual users registered participate on the social network without a paid subscription, in which the computing system is configured to process, store, and communicate data to facilitate the social network accessible to the business users and the consumer users by providing a first user interface on the remote computing devices of the consumer users and a second user interface on the remote computing devices of the business users.

The subject matter described in this patent document can be implemented in specific ways that provide one or more of the following features. For example, the disclosed online social network platform can provide a self-marketing application for retail businesses to reach out to their consumers, e.g., old and new, with updates relating to their business activities such as entertainment, flash specials on food/drinks/clothing, menu changes, etc. For example, the disclosed online social network provides a platform to connect to all businesses, e.g., particularly local businesses, based on a user's (e.g., old or new customer's) GPS location. For instance: a group of work colleagues are all planning on going to lunch together; they can simply open the mobile or web application of the disclosed social network platform, select businesses within a certain range (e.g., such as a range of their current GPS location), and get insight to the current business activities, e.g., such as what specials they have going on right now, environment, reviews, menus, etc. For example, using the disclosed social network platform, businesses registered to the social network will be given a “back office” through a business user application. This will give them control to their page online which will translate over to the individual user's application. Through their “back office” they can control what they post for “shout outs or newsfeed”(e.g., specials, capacity, lines, wait time, events), post pictures, add their menu, location, events, etc. For example, the back office provides business users control to schedule their postings onto a calendar that can translate over to the individual user's application at the specified times.

Those and other features are described in greater detail in the drawings, the description and the claims.

### BRIEF DESCRIPTION OF THE DRAWINGS

FIG. 1 shows a block diagram of an exemplary embodiment of an online social network platform.

FIG. 2A shows a diagram of a communication network for implementing the disclosed online social network platform.

FIG. 2B shows a block diagram of an exemplary computer system to implement the exemplary data processing, storage, and communication methods of the online social network platform.

FIG. 3 shows a process diagram of an exemplary method to provide direct, real-time advertising using the disclosed online social network platform.

FIGS. 4A-4E show exemplary display screens of the user interface provided on an exemplary mobile application of the disclosed online social network platform.

FIGS. 5A-5H show exemplary display screens of the user interface provided on an exemplary business user mobile application of the disclosed online social network platform.

FIG. 6A shows a flow chart diagram of an exemplary payment method of the disclosed social network platform.

FIG. 6B shows a process diagram of an exemplary method to determining payment for online posts to users of a social network using the disclosed technology.

FIG. 7 shows an example of a communication network for implementing the disclosed online social network platform.

### DETAILED DESCRIPTION

Mobile applications can be designed to maintain a degree of control over how the businesses, e.g., particularly local businesses, can market or advertise their products and services to their existing and potential/future customers. There can be differences or tensions between how and when businesses want to supply the information to their customers in their marketing or advertisement campaigns, and how and when consumers want to access such product/service information or find what they want when they want it. For example, one way for businesses to explore and reach out to customers is creating their own mobile app software to enable businesses to access a consumer loyal base, but this approach is based on some level of customer awareness of a particular business in order for customers to install the business mobile app, and thus may not be effective in connecting a particular business to other people or new customers that may be unaware of their business.

Techniques, systems, and devices are described for implementing an online social network platform designed for businesses (e.g., especially for retail businesses) to self-market directly to customers on mobile devices in real-time using the customer's geographical location (geo-location). The disclosed online social network platform provides the businesses with real-time marketing tools directly to previous customers and potentially new customers, including those local and visiting. In some implementations, the disclosed social network platform also provides business users with a business management platform connect to easily manage unique aspects of their business and connections with their customers using interactive user applications.

Implementations of the disclosed online social network platform include methods to provide advertising to a user of the social network platform directly and in real-time. For example, such direct, real-time advertisements are attained by connecting the businesses of the social network platform with individual users when the users request information about the business, e.g., rather than providing ‘blanket advertising to all users from sponsoring businesses that the user did not actively request information about. Also, in some implementations, such direct, real-time advertisements are attained by connecting the businesses of the social network platform with other businesses of the social network, e.g., such as suppliers and vendors for that business.

Implementations of the disclosed online social network platform include methods to provide a payment mechanism for registered business members to pay a service fee to a social media function provider based on the business member's activities, e.g., such a pay-per-post basis. For example, such payment mechanisms described herein transcend conventional mechanisms like direct ads or “sponsored stories” ads. The disclosed payment mechanism methods enable usage and activities undertaken by the consumer user on the disclosed online social network platform to be conducted free of charge to the consumer user.

The disclosed social network platform allows business users to connect directly with individual users (e.g., existing and prospective consumers) on a local basis, thus providing more effective and penetrating marketing and advertising opportunities in addition to and beyond what is available by marketing and advertising methods that mainly require an already existing connection between the business and the consumer. For example, the disclosed social network platform can be implemented on a mobile app that allows business users to post and individual users to gain real-time and relevant information about the businesses in the individual user's current local area based on the individual's location, e.g., such as information including ‘in the moment’ specials and incentives, upcoming events, current environment, and other factors like the business' pricing, reviews, and/or capacity. When an individual user of the social network is in a regional area of registered businesses of the social network, the user can use a mobile application of the social network platform to acquire information about businesses in the regional area that the user selects, e.g., which can be based on a filtered search initiated by the user. In effect, the individual users ‘pull’ the information about the local businesses they are interested in to learn about the ‘in the moment’ specials and incentives, upcoming events, current environment, and other exemplary factors of the businesses of interest. Additionally, the individual users can receive the real-time and relevant information about the businesses with which the consumer has established a relationship or connection via the social network platform, e.g., push notifications. For example, the consumer users have the ability to “Follow” and/or “Favorite”/“like” businesses, e.g., which can create a loyal connection to each business they select. The disclosed social network platform can permit users to opt-in in order to receive push-notifications from that business.

The disclosed social network platform enables businesses, e.g., particularly local businesses, to level the playing field with other local businesses in a marketing competition to earn the business of consumers. By giving registered companies a platform to extend their ‘voice’ directly to local consumers, the disclosed social network platform enables businesses to update their target market with information on what the business is doing right now to entice consumers nearby to their establishment, as well as the individual users who follow/have a connection with the business who may not currently be nearby. For example, business users can present their best, limited time offers to consumers using the mobile application of the disclosed social network platform, and consumer users can readily and easily access and compare such offers in choosing if and where they wish to go.

The disclosed social network platform provides business users with the ability to manage and edit their own mobile application site and/or website of the social network platform, enabling the business user to promote and market their products and services in real-time, as well as directly respond to their customers' using the mobile application site and/or website to manage ‘in the moment’ needs of the customers. The disclosed social network platform provides individual users (e.g., the existing and prospective customers of the registered businesses of the social network platform) with real-time information and updates upon request from the individual user, e.g., such as advertisements of limited time promotions, from the registered businesses in their current local area, as well as such real-time information and updates from registered businesses in a user-specified location. For example, the disclosed social network platform provides a forum for individual users to share experiences and values with like-minded individuals about businesses in their geographical area. Moreover, the disclosed social network platform provides the registered business users with transparent and accountable customer engagement with their existing and future customers. For example, this can be through the review process, in which the consumer users can submit reviews and other users would rate those reviews.

In some implementations, the disclosed social network platform can provide business users with their own marketing material to display that will drive their customers to download the application and get connected with that business. For example, the disclosed social network platform can implement a viral loop marketing technique where each registered business of the social network markets the social network to their existing customers and new customers (e.g., through signage in their business establishment, on their online business website, etc.) to encourage and entice these customers to join the social network and follow/favorite the business. For example, the customers can register as individual users of the social network and download the application (e.g., such as a mobile application to a mobile communications device of the user). Each business thus may bring such individual users (e.g., new consumers) into the social network, thereby providing the registered businesses with access to potentially new customers/clients. Additionally, for example, individual users and business users can engage with their ‘friends’ on other existing social media networks to encourage them to join the disclosed social network.

Furthermore, the disclosed social network platform increases efficiencies of computing and data communication resources on computer systems of the business users and individual users. For example, the disclosed social network platform provides a centralized computer system to collect and analyze data and perform actions based on the analyzed data that reduces excess computational resources on client and/or server computers of the business owners as well as the client computing devices (e.g., smartphones) of the individual users. Moreover, by providing a centralized computer system, for example, the disclosed social network platform reduces network traffic that in turn increases efficiencies on the communication infrastructure of the Internet. Such increased efficiencies are created by the disclosed social network platform while also generating connections between businesses and customers in a local setting, providing direct and real-time marketing mechanisms that promote can promote ‘in the moment’ specials, and producing management and analytics tools, among other end user benefits.

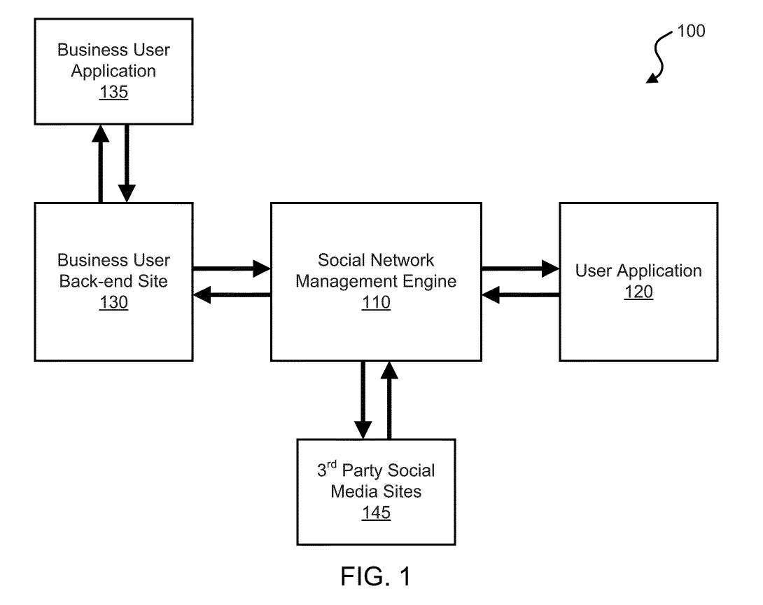

FIG. 1 shows a block diagram of an exemplary embodiment of an online social network platform 100 of the disclosed technology. The online social network platform 100 includes a social network management engine 110 implemented on one or more computer systems to perform the various data processing, data storing, and data communications functions to facilitate the online social network to the business users and the individual users. The online social network platform 100 includes a user application 120 resident on a computer device including a desktop or laptop computer of an individual user of the social network, and/or a mobile communications device of the individual user of the social network, e.g., which can include a smartphone, a tablet, and/or a wearable communications device, e.g., such as a smart-watch or smart-glasses. The user application 120 is in data communication with the social network management engine 110, in which data can be processed by the social network management engine 110 on the one or more computer systems or by the user application 120 on the computer device of the individual user, based on the data processing operation. In some implementations, for example, the user application 120 includes a mobile application on the mobile communications device of the individual user which provides an interactive user interface to display and receive data to and from the user. The online social network platform 100 includes a back-end site or web portal 130 available to registered business users with the social network and resident on a computer device of the business user. The back-end site or web portal 130 is in data communication with the social network management engine 110, in which data can be processed by the social network management engine 110 on the one or more computer systems or by the back-end site or web portal 130 on the computer device of the business user, based on the data processing operation. For example, the online social network platform 100 can include a business user application 135 resident on a computer device including a desktop or laptop computer of a registered business user of the social network, and/or a mobile communications device of the registered business user of the social network, e.g., which can include a smartphone, a tablet, and/or a wearable communications device, e.g., such as a smart-watch or smart-glasses. In some implementations, for example, the online social network platform 100 can be in communication with other (3^{rd} party) social media sites 145, e.g., such as Facebook, Twitter, LinkedIn, or other, to receive information about individual users that authorize the online social network platform 100 to have access to user selected content from their account, e.g., such as user information about the individual profile, user's connections (e.g., friends, contacts, followers, groups, etc.), or other content from the 3^{rd} party social media site. In some implementations, for example, the online social network platform 100 can be in communication with the 3^{rd} party social media sites 145 to provide data to the 3^{rd} party social media site, e.g., to post data on the individual user's space (e.g., profile) or send a communication within the 3^{rd} party social media site 145 (e.g., to the user's friend, contact, etc.).

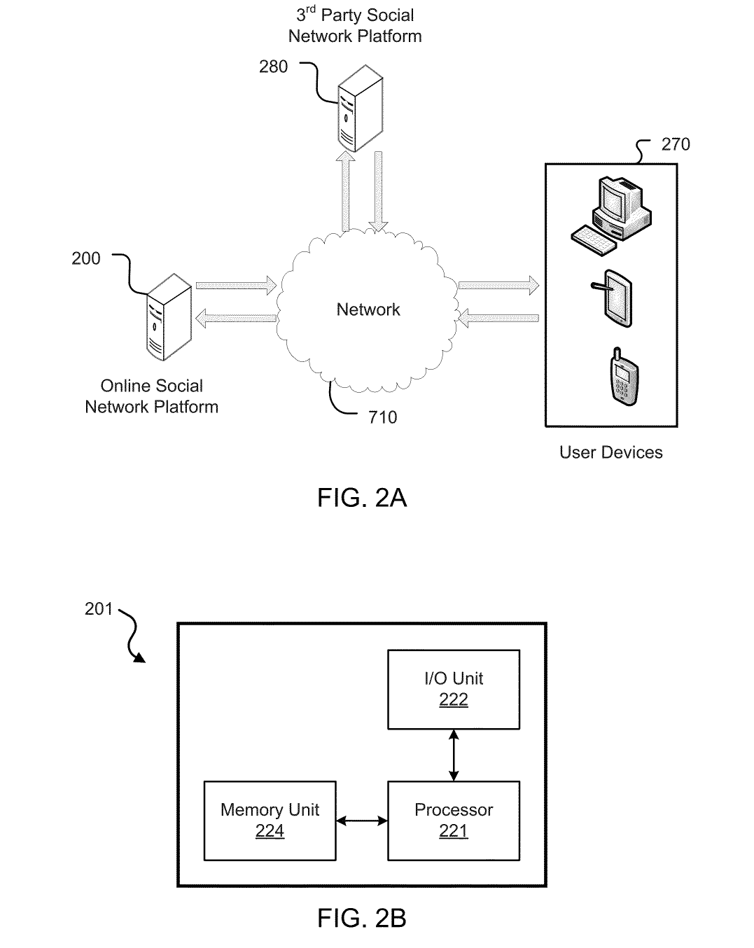

FIG. 2A shows a diagram of an exemplary computer system 200 in a communication network to implement the exemplary methods of the disclosed social network platform. For example, the computer system 200 can be included as part of a communication network 710 of computing devices accessible via the Internet (referred to as ‘the cloud’) that includes one or more remote computational processing devices (e.g., servers in the cloud). The computer system 200 can operate the social network management engine 110 shown in FIG. 1. As shown in the diagram, the computer system 200 can operate as a social network platform data center in communication with the business users and the individual users via their client devices 270, as well as 3^{rd} party social network data centers 280 (e.g., servers of the other respective online social network platforms).

The computer system 200 can include one or more computers in data communication with each other and with other computers, e.g., such as the computing devices of the business users and the individual users, over the communication network 710. FIG. 2B shows a block diagram of an example computer 201 of the computer system 200. As shown in the diagram, the computer 201 of the computer system 200 can include a processor 221 to process data in communication with a memory unit 224 to store data. For example, the processor 221 can include a central processing unit (CPU) or a microcontroller unit (MCU). For example, the memory unit 224 can include processor-executable code, which when executed by the processor 221, configures the computer 201 of the computer system 200 to perform various operations of the disclosed social network platform, e.g., such as receiving information, commands, and/or data, processing information and data, and transmitting or providing information/data to another entity or to a user.

To support various functions of the computer 201 of the computer system 200, the memory unit 224 can store various types of information and data, e.g., such as instructions, software, values, images, and other data processed or referenced by the processor 221. Various types of Random Access Memory (RAM) devices, Read Only Memory (ROM) devices, Flash Memory devices, and other suitable storage media can be used to implement storage functions of the memory unit 224. The memory unit 224 can store data and information, which can include sample data, and information about other units of the social network platform, e.g., such as individual user and business user device unit parameters, and hardware constraints, as well as software parameters and programs.

The computer 201 of the computer system 200 can include an I/O unit 222 that can be connected to an external interface, source of data storage, or display device. Various types of wired or wireless interfaces compatible with typical data communication standards can be used in communications of the computer system 200 with the various devices of the individual users and business users of the disclosed social network platform, e.g., including, but not limited to, Universal Serial Bus (USB), IEEE 1394 (FireWire), Bluetooth, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces. The I/O unit 222 can also interface with other external interfaces, sources of data storage, and/or visual or audio display devices, etc. to retrieve and transfer data and information that can be processed by the processor 221, stored in the memory unit 224, or exhibited on an output unit associated with the online social network platform.

Exemplary Advertising Methods

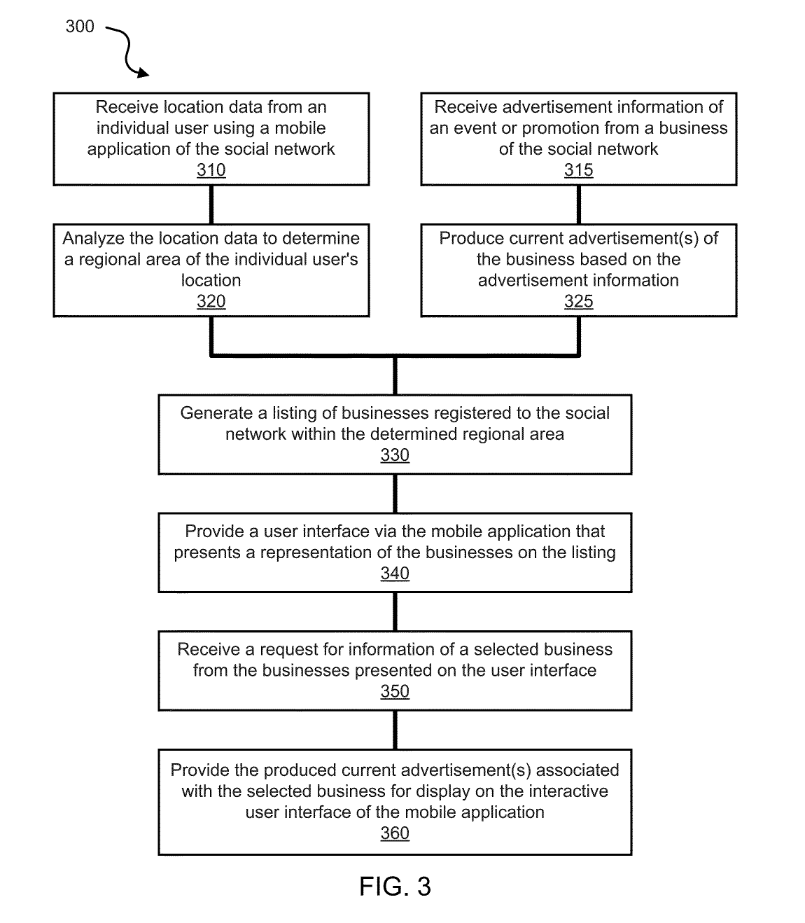

In some aspects of the disclosed social network platform, a method to provide direct advertising in real-time to a user includes the following computer-implemented processes, as shown in FIG. 3. The method, labelled method 300 in FIG. 3, can be implemented by a computer system, like the computer system 200 of FIG. 2B. The method 300 includes a process 310 to receive, at a computer system, location data from a mobile communications device of an individual user using a mobile application of a social network. For example, the mobile communications device of the individual user can include at least one of a smartphone, a tablet, or a wearable communications device including a smart-watch or a smart-glasses. The method 300 includes a process 320 to analyze, in the computer system, the received location data to determine a regional area of the individual user's location based on a range defined by the location data and a distance setting associated with the individual user stored in the computer system. For example, the distance setting associated with the individual user can be determined by the individual user using the mobile application, and can be stored by one or both of the mobile communications device of the user and the computer system. The method 300 can include a process 315 to receive, at the computer system, advertisement information of an event or promotion from a business registered with the social network. For example, the event or the promotion can include an ongoing or an upcoming event or promotion. The method 300 can include a process 325 to produce, at the computer system, one or more current advertisements associated with the business based on the received advertisement information. For example, the process 325 can be implemented for a plurality of businesses registered with the social network. The method 300 includes a process 330 to generate, in the computer system, a listing of businesses registered to the social network within the determined regional area. The method 300 includes a process 340 to provide, by the computer system, an interactive user interface on the mobile communications device via the mobile application that presents to the individual user a graphic and/or textual representation of the businesses on the generated listing. For example, the presented representation of the businesses on the listing can include one or more of name of the businesses, location information of the businesses, and business type of the businesses. The method 300 includes a process 350 to receive, at the computer system, a request by the individual user for information of a selected business chosen by the individual user from the businesses presented on the interactive user interface. The method 300 includes a process 360 to provide, by the computer system, the produced one or more current advertisements associated with the selected business for display on the interactive user interface of the mobile application.

In some implementations, for example, the method 300 can further include a process to receive, at the computer system, subsequent advertisement information of another event or promotion from the business. In such implementations, for example, the method can repeat the process 325 to produce the one or more current advertisements associated with the business based on one or both of the received advertisement information and the subsequent advertisement information.

Exemplary User Application

Examples of the user application 120, e.g., which can include the mobile application implemented in the method 300, to facilitate an immediate, direct connection between the businesses and the individual users are described. In some examples, the user application 120 can provide the registered businesses with an online vehicle for direct, instantaneous, real-time self-marketing to the individual users of the social network, e.g., including marketing reviews, specials and incentives, events, environment, capacity, pricing, and other information about the business. Members businesses of the social network can utilize the user application 120 to maintain a unique presence within the social network accessible to any users, and can utilize the application 120 to solicit customers, announce events, post information, and promote specials and incentives, for example. The individual users of the social network can access the user application 120 to find businesses in the area that provide a desired service. For example, current information on restaurants, nightclubs, specialty services (e.g., such as dentists, spas, animal grooming, etc.) and clothing retailers, among other types of business, will be readily available to the individual users implementing the user application 120. The user application 120 includes a specially-designed interactive user interface presenting and receiving information to and from the user through a variety of modalities, e.g., including graphically, textually, and auditory. The user application 120 can be implemented to recognize user preferences of the individual user that logs into the social network using the application 120, as well as supply the individual user 120 with a ‘feed’ of information based on a search by the user and/or previous utilization habits of the user.

Exemplary functional features available to the individual users of the exemplary user application 120 implemented on a mobile communications device, e.g., referred here to as the mobile application 120, can include a search feature to perform a search of businesses registered to the social network, e.g., including various filter functions to filter the search (for example, such as by distance, by name, by business open hours, by type of business and sub-types of the business, among other factors). Another exemplary feature of the exemplary mobile application 120 can include a user location search, e.g., using GPS data provided by the user's mobile communication device (e.g., GPS integration of the network management engine 110 with the operating system of the mobile communications device). For example, the user location can be used to determine the range of businesses displayed and/or searched, e.g., such as a radial range of 1 miles, 2 miles, 5 miles, 10 miles, or other. Another exemplary feature of the exemplary mobile application 120 can include an information post of the registered businesses with the social network, e.g., which can be integrated with other existing social networks. For example, the business' information posts can be integrated with the ‘news-feed’ of Facebook, e.g., which can streamline posts across multiple social networks. For example, the social network management engine 110 can also allow a user to post directly to other social media from the disclosed social network platform. Examples of other social media that disclosed social network platform can integrate with can include, but is not limited to, Facebook, Twitter, LinkedIn, Google+, Instagram, Reddit, Tumblr, Foursquare, Mixi, MailChimp, MySpace, Friendster, Storify, Vimeo and YouTube, among others. Another exemplary feature of the exemplary mobile application 120 can include user filters of the information posts by the registered businesses to screen what information from the posts (e.g., ‘news-feed’) is presented to the user on the interactive user interface display. For example, such filter functions can include proximity of the businesses to the user, type of information on the post (e.g., such as a concert, special, coupon, etc.), and time-of-post (e.g., filtering most recent posts from older posts, or any temporal range of the posts). Another exemplary feature of the exemplary mobile application 120 can include links to other existing social networks, e.g., such as Facebook profiles, to allow input of data from the other existing social network (e.g., such as list of ‘friends’) into the disclosed social network, and to allow users the ability to share postings from the other existing social network they like on their page of the disclosed social network. Another exemplary feature of the exemplary mobile application 120 can include connections to map-based applications on the individual user's mobile communication device, e.g., to get directions to businesses or view a map. Another exemplary feature of the exemplary mobile application 120 can include a ‘Favorites’ addition feature to add user-selected businesses to a list unique to the individual user. For example, by adding a registered business to the ‘Favorite’ list, the mobile application 120 can present push notifications from those businesses, e.g., provided by the social network management engine 110 (e.g., push notification integration of the network management engine 110 with the operating system of the mobile communications device).

Exemplary functional features available to the business users of the exemplary user application 135 implemented on a mobile communications device, e.g., referred to here as the business mobile application 135, can include a calendar for businesses to schedule their posts ahead of time. Another exemplary feature of the exemplary business mobile application 135 can include a Membership Administration Panel to interact with the database of the business user back-end site 130 to facilitate a service fee/payment method for business subscribers (e.g., businesses registered with the social network).

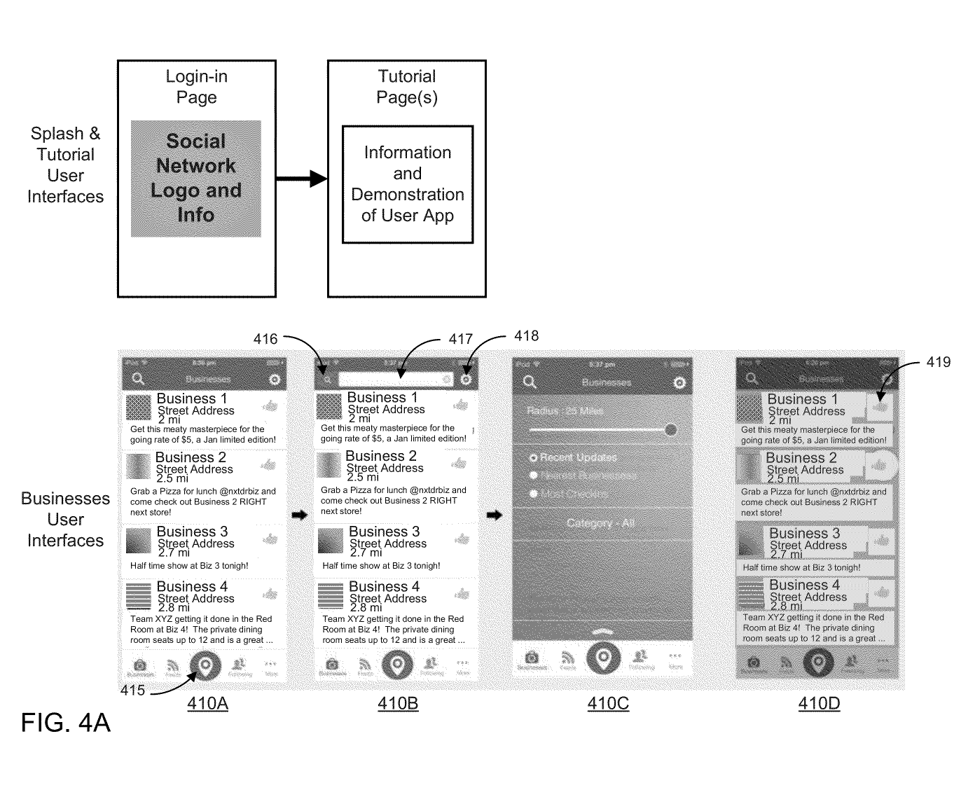

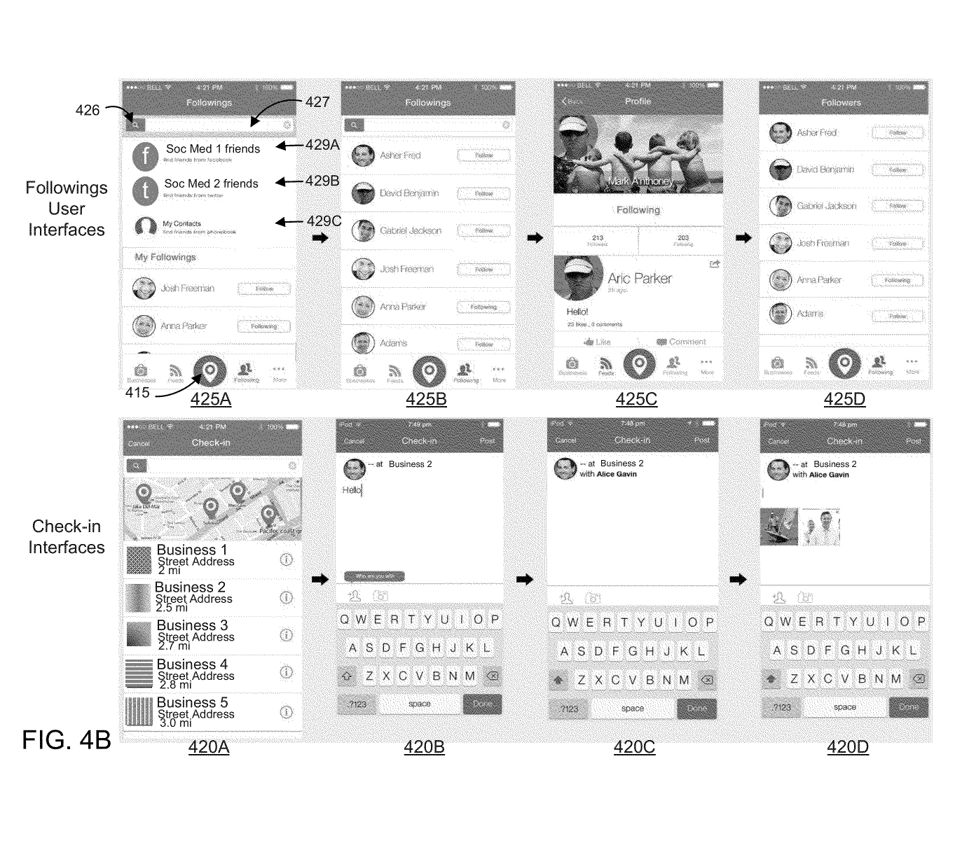

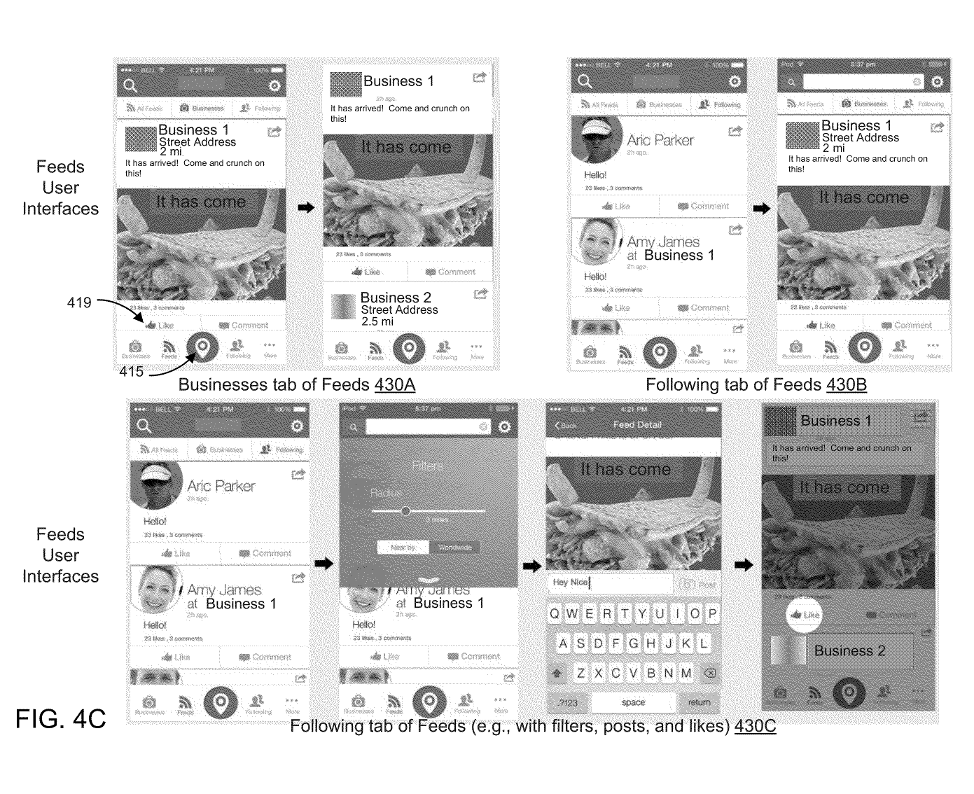

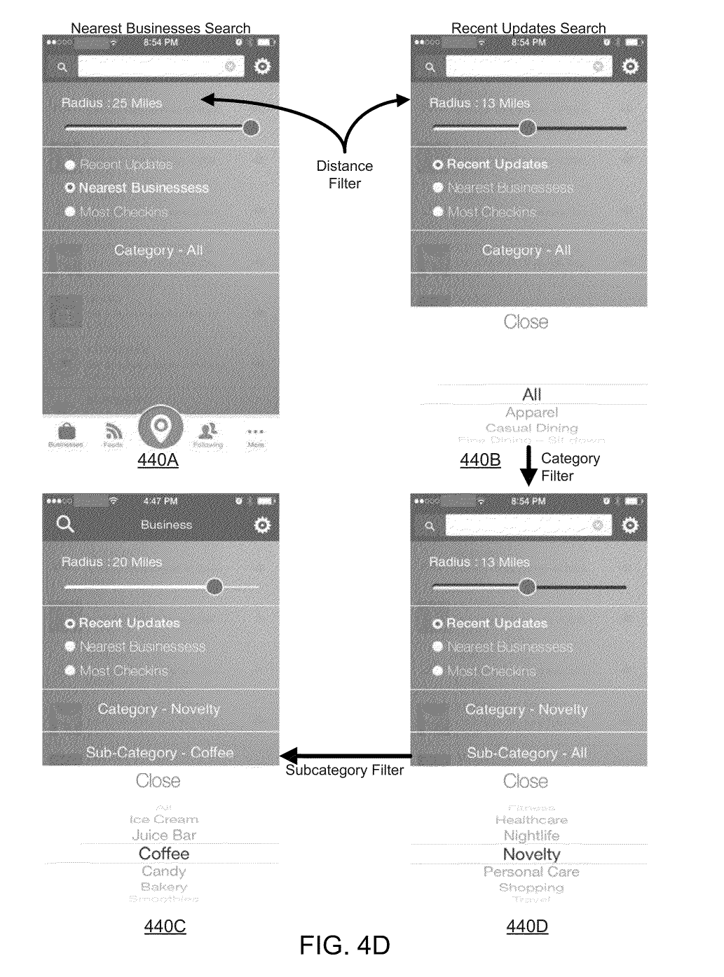

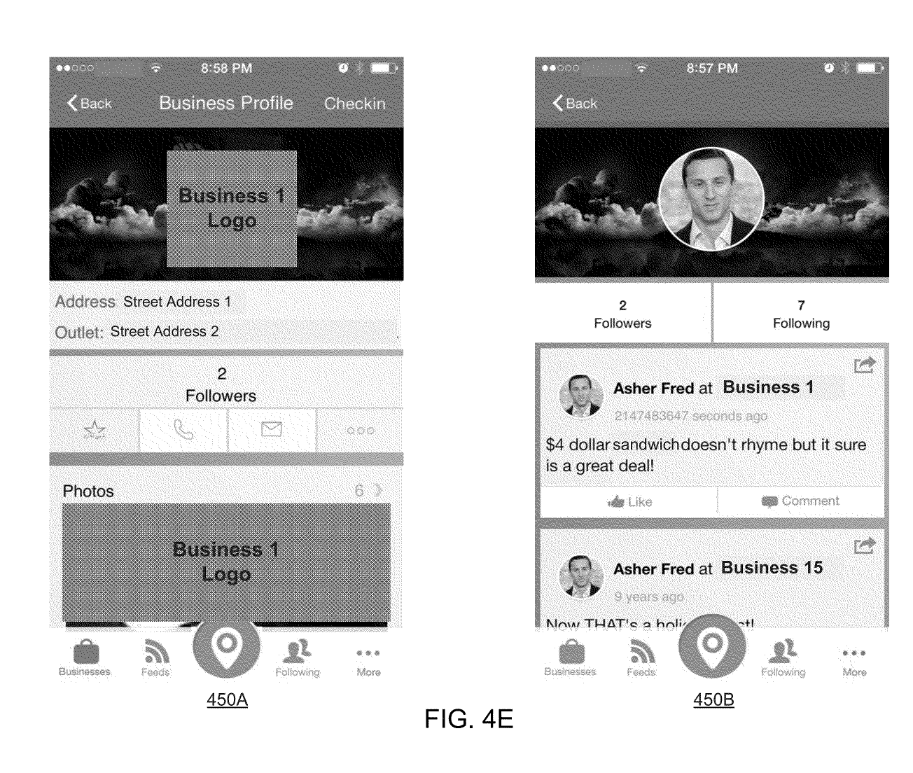

For example, the interactive user interface can include a display screen providing a listing of the businesses in the determined regional area as a list of businesses. FIGS. 4A-4E show exemplary screen-shot images of examples of the display screens of the mobile application 120 providing the listing of local businesses to the individual user. FIG. 4A shows exemplary illustrative screen-shot diagrams of user interfaces of a login-in page interface and tutorial page(s) interface and user interfaces of businesses page interfaces, e.g., showing an exemplary display of the listing of businesses within the determined regional area. FIG. 4B shows exemplary illustrative screen-shot diagrams of user interfaces of followings page interfaces and individual user check-in page interfaces, e.g., showing an exemplary list and map display of the listing of businesses within the determined regional area enabling user interaction to select a business and check-in to the business. FIG. 4C shows exemplary illustrative screen-shot diagrams of user interfaces of feeds page interfaces, e.g., showing an exemplary list of feeds on various tabs, such as businesses tabs and followings tabs. FIG. 4D shows exemplary illustrative screen-shot diagrams of user interfaces of businesses search page interfaces, e.g., including nearest businesses based search, recent updates based search, and/or most check-ins based search options, along with distance, categories, and sub-categories filters. FIG. 4E shows exemplary illustrative screen-shot diagrams of user interfaces of a business user profile page interface and an individual user profile page interface.

For example, in the businesses tab of the exemplary listing of businesses, the application can list the businesses in the vicinity of the user. For example, a business member's last update can be displayed in flash text below the business name, as shown in the screen display diagrams 410A and 410B of FIG. 4A. For example, by the individual user tapping the magnifying glass 416, the interactive user interface of the application will open a search box 417, e.g., allowing the users to search for a specific business. For example, an individual user can click on the exemplary preferences button 418 on the top right corner of the business tab of the exemplary listing of businesses to cause the interactive user interface to pull down an options menu (shown in the screen display diagram 410C in FIG. 4A). In this option menu, the user can elect to sort businesses based on different listed criteria, e.g., Recent Updates, Vicinity, Most Check-ins, and Category. For example, tapping on the business' name or icon from the business tab will open the specified profile of the business, which displays the businesses' identifying information and data feeds, as shown in the FIG. 4C. For example, the individual user can have the option of tapping on the address to access a map view. For example, tapping a call button will launch a calling interface of the application, and tapping the email button will launch the user's mobile communication device's default email application. For example, tapping on the ‘like’ button 419 (e.g., shown as a Thumbs Up icon on the exemplary interactive user interface shown in FIGS. 4A and 4C) will add the business to the user's personal list of Liked Business. For example, the user can automatically receive updates from all liked businesses, and can search for a list of their Liked Business by using the search with such filters (e.g., tapping on the magnifying glass button to initiate a search).

Referring to FIG. 4A, a check-in button 415 can be prominently displayed below the listings in a panel on the interactive user interface, as shown in FIG. 4A (e.g.. bottom center). For example, by an individual user tapping the check-in button 415, a list of businesses within a predetermined distance of the user will open (e.g., such as 5 miles of the user), e.g., which can be sorted by distance, alphabetical or other ways based on user preferences.

In some exemplary displays of the interactive user interface of the application, the listing of businesses can be marked on a map, as shown in the screen display diagram 420A of FIG. 4B. For example, from the Check-In interface, as shown in the screen display diagrams 420A-420D of FIG. 4B, the individual users can update their location status as they arrive at a business member's establishment. For example, location notifications can be posted to user's selected social media accounts of other social networks. For example, as shown in FIG. 4B, when the user taps the check-in button, the top and bottom action bars will slide out of view, and a map displaying nearby businesses and search options will open, as shown in the screen display diagram 420A. Tapping on any business, for example, will navigate the user to the Check in/Post Feed display screen (e.g., shown in the screen display diagrams 420B, 420C, and 420D of exemplary check-in interfaces in FIG. 4B). In the exemplary Check In/Post Feed interface, users can update their check-in message, tag friends, and/or upload images.

In some exemplary displays of the interactive user interface of the application, an interface can be used to provide an interactive list of the individual profiles that the user has elected to ‘follow’, as shown in the screen display diagrams 425A-425D of FIG. 4B. For example, the individual users can access available social media profiles from other existing social networks 429A and 429B (e.g., such as Facebook, Twitter) and/or access Contacts 429C (e.g., of the Contacts list in their mobile communications device) to locate user profiles. For example, upon tapping any of these exemplary options, the friends from that particular circle will be displayed, as shown in the screen display diagram 425B. The individual user can search for a specific individual using the search box 427 of the exemplary followings tab. The user can then choose to follow or unfollow any person. For example, when user clicks on cross button, the list can be hidden. For example, the individual users can search for a specific profile in the exemplary followed list, e.g., by clicking on the magnifying glass 426 in the top left corner of the interface display. For example, the displayed list can be filtered using the Preferences option of the application. For example, tapping on an image or name will open his or her profile, as shown in the screen display diagram 425C.

In some exemplary displays of the interactive user interface of the application, the feed interface provides an interactive list of updates from all of the user's Liked Businesses and followed users, as shown in FIG. 4C. The exemplary screen display diagram 430A shows an example of a list of feeds on businesses, and the exemplary screen display diagrams 430B and 430C show examples of a list of feeds of a user's followings. For example, there are several types of feeds of the interactive user interface, e.g., including, but not limited to, a friend's check in, a friend's check in with image, a friend liked friend's check in, a friend liked business feed, and a business Sale/Promotion with image and/or text. For example, feeds can be displayed based on the user's selected filters, as shown in FIG. 4D. FIG. 4D shows exemplary screen display diagrams 440A-440D depicting user filters including nearest businesses based search (e.g., diagram 440A), recent updates based search (e.g., diagram 440B), and/or most check-ins based search options, along with distance, categories, and sub-categories filters. Also, for example, when the user scrolls through the feeds on the home screen, the tab and action bars can auto-hide and the feeds can be displayed in full screen mode.

As shown in the exemplary screen-shot diagrams of FIG. 4E, the business profile display as shown in the screen display diagram 450A can contain the following exemplary elements, including the business' address, cover photo, profile photo, links to call, email and/or use another existing social network (e.g., such as Facebook), number of followers, and link to follow the business. FIG. 4E also shows an exemplary screen display diagram 450B of an individual user profile page interface, which can contain the user's cover photo, the number of user's followers and followings, e.g. linking to such listings, and recent posts made by the user, among other example elements.

Exemplary Business User Application

Examples of the business user application 135 to facilitate an immediate, direct communication of the businesses with the business user back-end site or portal 130 are described. For example, the business user application 135 can include a mobile application and/or a web-based application that can be implemented by the business users, e.g., such as in the method 300. The business user back-end site 135 can be configured as a web-based portal to the user application 120, operated via the social network management engine 110. The business user back-end site 135 and access to it via the business user (web or mobile) application 135 be utilized by member businesses' web administrators to manage the profile and feeds of the business.

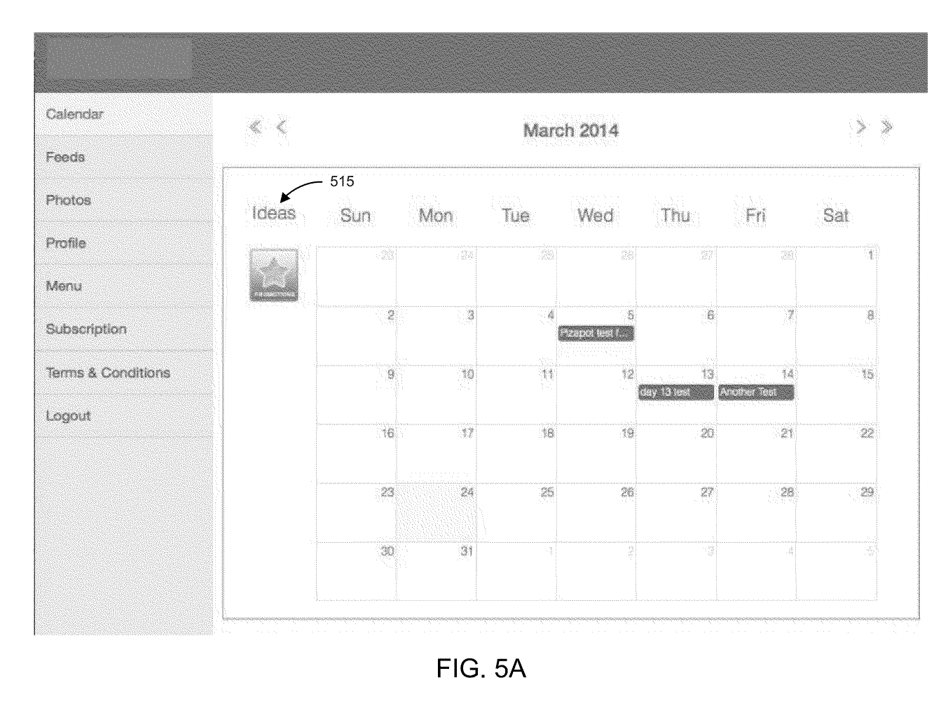

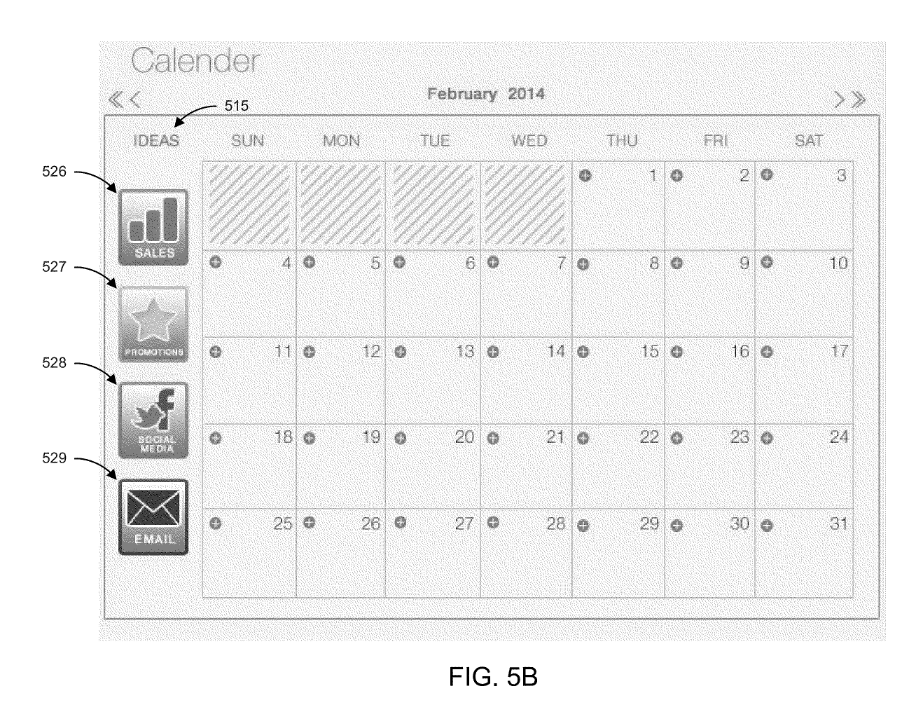

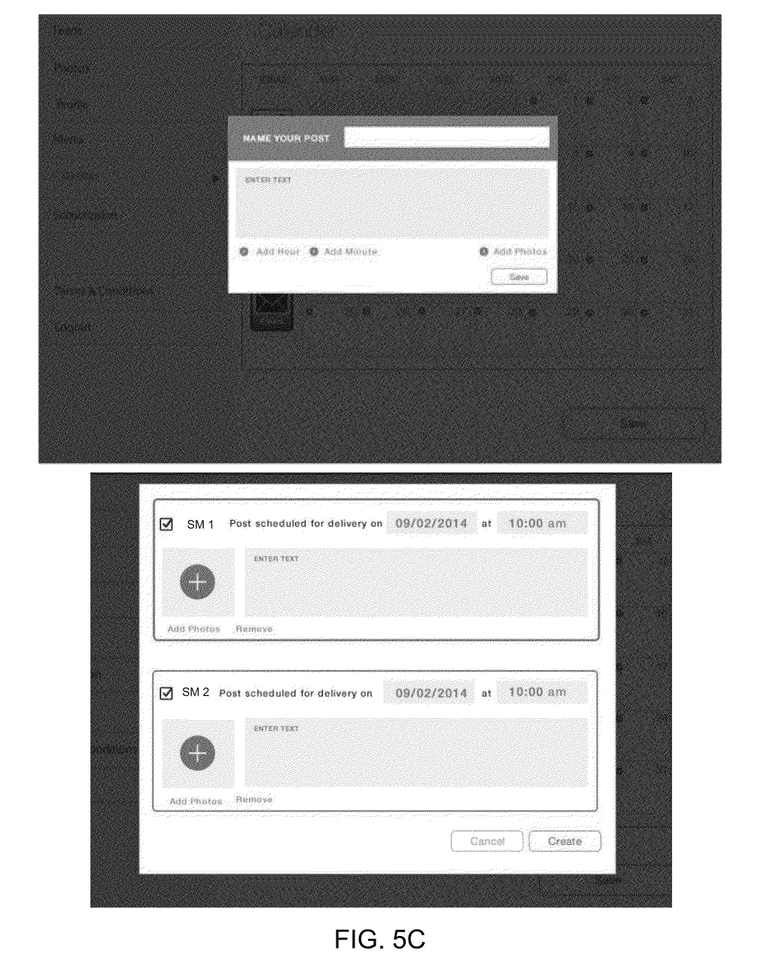

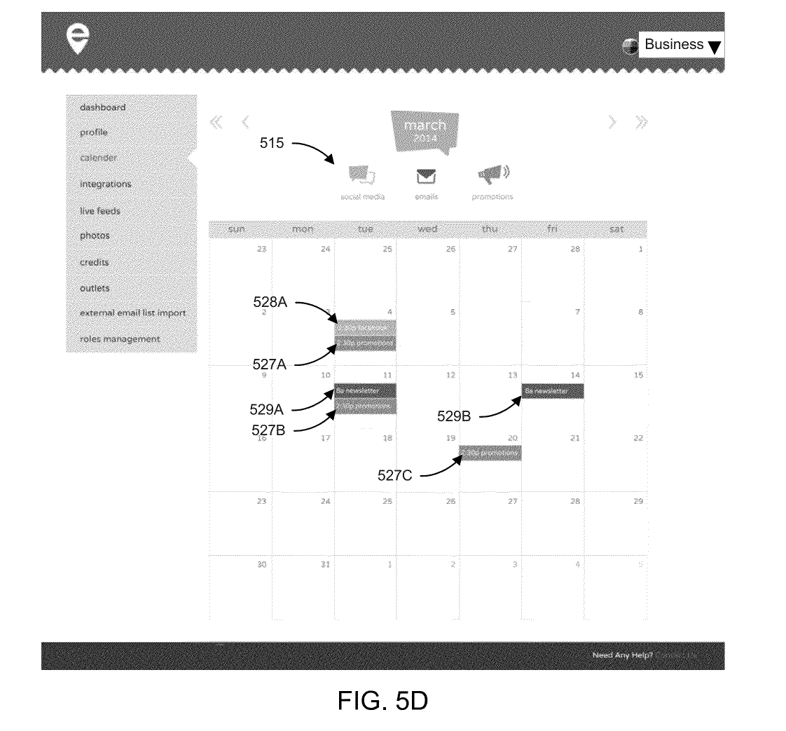

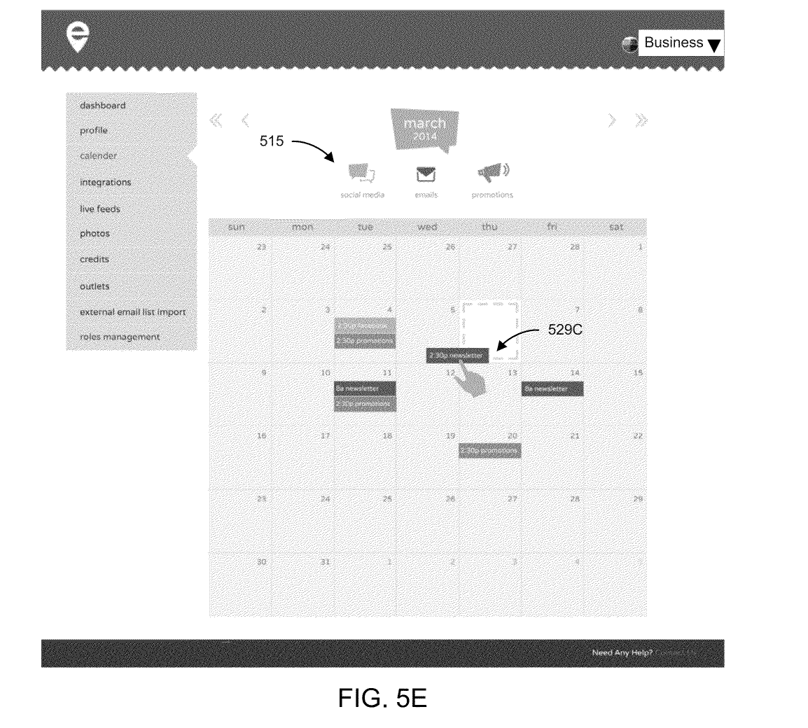

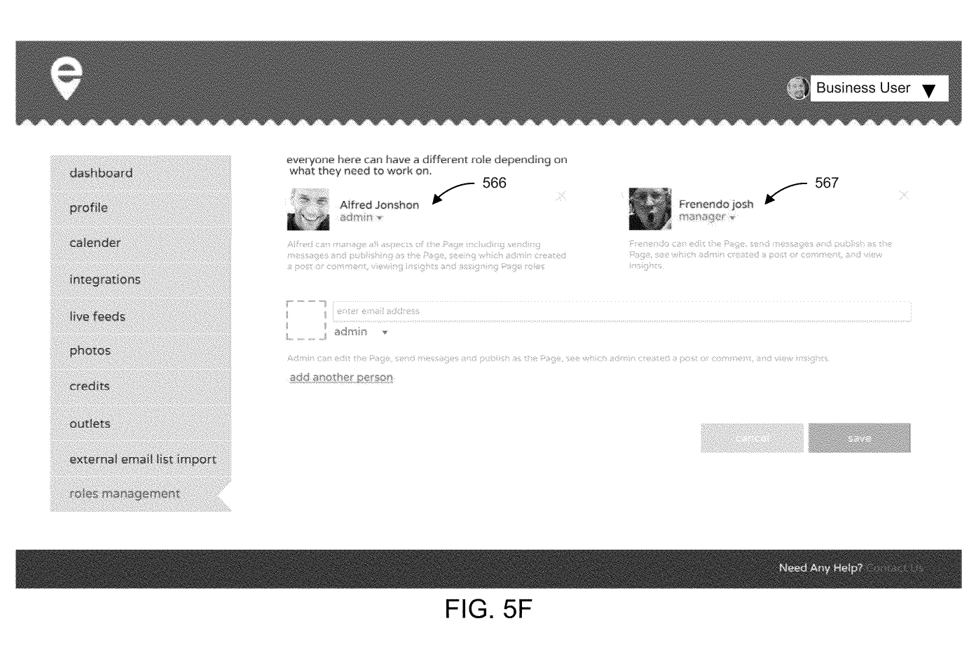

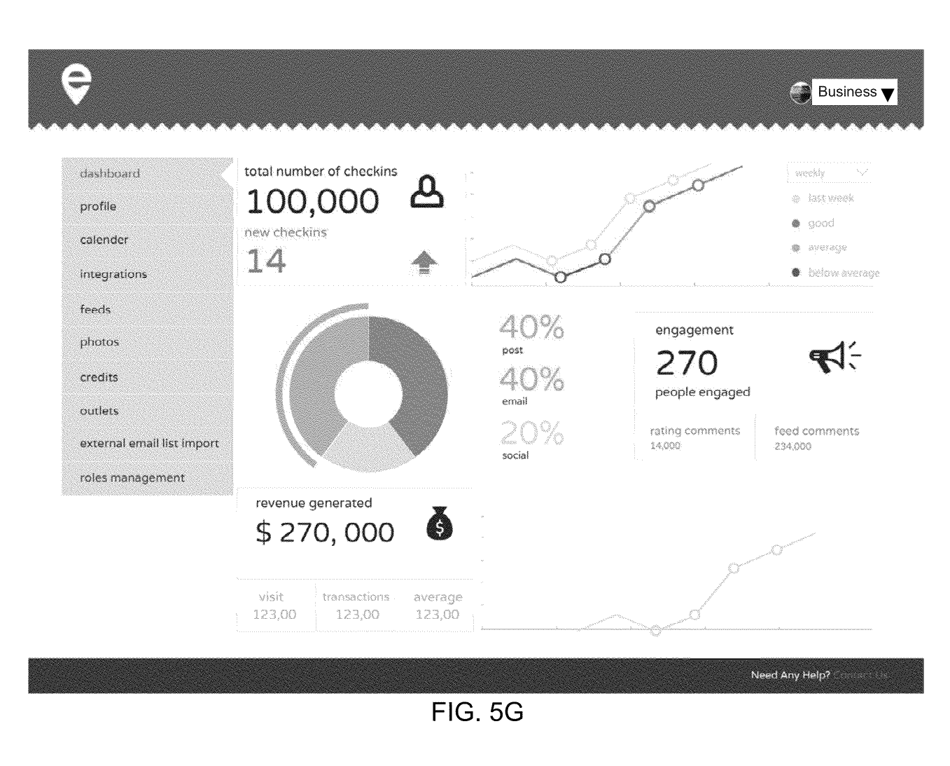

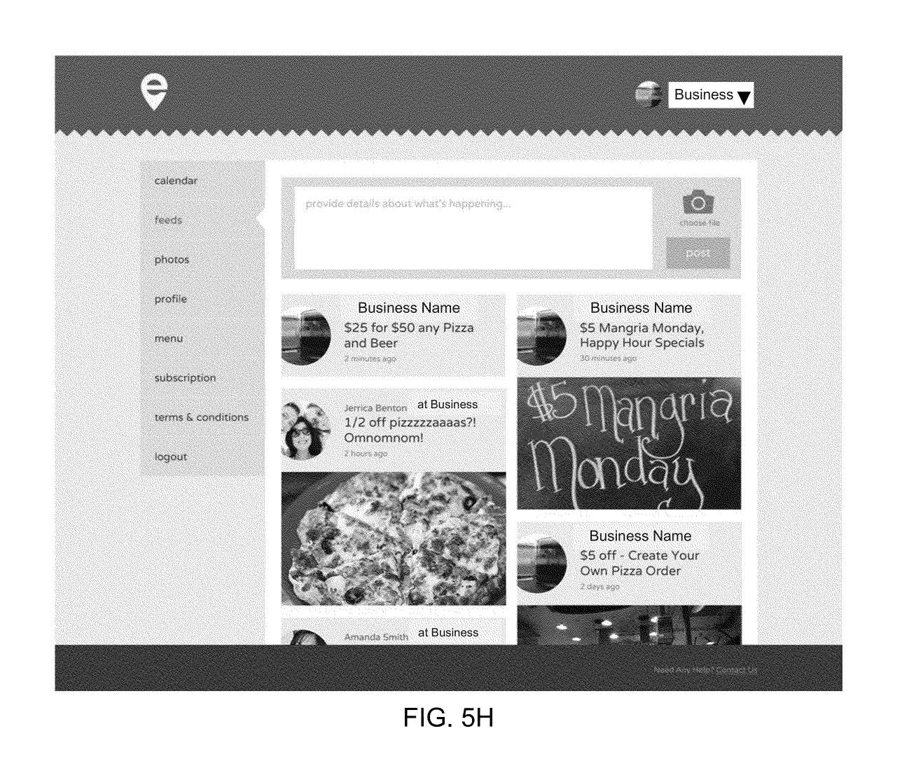

FIGS. 5A-5H show exemplary screen-shot images of examples of the display screens of the business user application 135 providing tools to manage the business profile of the disclosed online social network platform. FIG. 5A shows an exemplary interactive user interface of a calendar tool of the business user back-end site 130 that can be displayed using the application 135. For example, the left side of the calendar tool includes the Idea Bar 515 which can contain default, pre-configured feed items. Business users (e.g., business managers) can drag and drop items from the Idea Bar 515 onto the calendar to quickly schedule marketing feeds. FIG. 5B shows a calendar view with the Idea Bar implemented. For example, the Idea Bar includes a Sales item 526, a Promotion item 527, a Social Media item 528, and a communication item (e.g., emails, newsletters, etc.) 529. For example, as shown in FIG. 5C, when a Sales item 526 or Promotion item 527 is dropped onto the calendar, a feed box will open containing default, applicable text. Business managers can ‘Name The Post’ for use in future marketing strategies, attach images, and/or specify a time for the item to go live.

FIG. 5D shows a calendar view of the exemplary user interface for business users including promotion type actions and feeds 527A-527C, social media type events and feeds 528A, and communication type actions and feeds 529A and 529B. FIG. 5E shows a calendar view of the exemplary user interface for business users depicting the business user dragging a communication type action 529C to a particular day on the calendar. FIG. 5F shows a roles management page of the exemplary user interface for business users showing multiple business users (e.g., admin user 566, and manager user 567) associated with a business creating and modifying a post to the social media site.

FIG. 5G shows an analytics page (e.g., which can be part of the dashboard page) of the exemplary user interface for business users featuring data analytics analyzed by the social network platform (e.g., engine 110) and provided to the business user. For example, the analytics data can be displayed in textual, graphical, or other type formats, and can display the analytics data at particular (e.g., user selected) instances of time or time durations. The analytics data can include, but is not limited to, for example, the number of check-ins by individual user's to the business, new check-ins, number of comments and/or feeds referencing the business, financial data (e.g., revenue generated, transactions, etc.), among other types of business-related data to the social network platform. The analytics page can display comparative data for the analytics data between different time periods, or among different types of users (e.g., based on user information, such as age, gender, location, etc.)).

The exemplary interactive user interface of the feeds tool of the business user back-end site 130 can be displayed using the application 135. For example, an exemplary page of the exemplary user interface of the feeds tool can display all the published feeds of a particular business, e.g., providing a representation of a business. For example, the supported feed types can remain the same as those for the mobile client. FIG. 5H shows a business feeds page of the exemplary user interface for business users featuring posts, comments, and other feeds created by the business user and individual users, provided by the social network platform (e.g., engine 110). In the example shown in FIG. 5H, the business posts an ‘in the moment’ special (e.g., “$25 for $50 of any Pizza and Beer”), and individual users post comments (e.g., “½ off pizzzzzaaaas?! Omnomnom!”, in which the individual user may have checked-in to the business.

The exemplary interactive user interface of the photos tool of the business user back-end site 130 can be displayed using the application 135. For example, an exemplary page of the exemplary user interface of the photos tool can display all images uploaded by a member business, e.g., in chronological order. For example, the business user may add images to the repository for future use.

The exemplary interactive user interface of the profile tool of the business user back-end site 130 can be displayed using the application 135. For example, an exemplary page of the exemplary user interface of the profile tool can allow business administrators to configure data for the business profiles that will eventually be displayed in the mobile client applications, e.g., such as the business cover image, business profile/logo image, name of the business, and contact information including phone number(s) that an individual can use to reach the business, email address, and/or a web URL pointing to the website of that brand.

For example, the business members of the disclosed social network platform can receive a variety of benefits. Exemplary benefits to business users include, but are not limited to, for example, GPS location based marketing and advertising; ability to post specials or offerings through the website and mobile based applications to individual users (e.g., existing and perspective consumers); ability to announce incentives in real-time at the discretion of the business user manager (e.g., such as, “Ladies Night” if business user manager notice more males then females, “Buy 1 Get 1 . . . ” for a select time windows, “Free Entry” for select time windows, etc.—which can help stay ahead of the competition if other local venues have big events going on); ability to update consumers on capacity, current wait times, and make easily reservations, etc.; ability to announce events (e.g., such as live music); announce in-the-moment, current daily, & nightly menu item specials; ability to post real-time updates on new products; ability to mass-market to local consumers for ‘Flash-Sales’; and aid in bringing consumers away from internet sales and into your store where they can physically see and try the product (e.g., as many Internet sales generally have no or cumbersome return policies). For example, this allows the business users to save time and money each time a special is sent out/posted, and allow them to track which specials are being used the most—for example, the business users have a method to learn if they advertisements are effective on an individual-by-individual basis. For example, the disclosed online social network platform can allow for the elimination most of the marketing needs of the business users, e.g., and therefore essentially allow a business user to eliminate a series of marketing costs. For example, this can also transcend to cost-saving in other cost areas, e.g., such as loss of over-purchase/production of food for restaurant, coffee shop, and bar/grill type business users, and loss of having unneeded employees working at the business when business is slow.

The exemplary business user back-end site 130 (e.g., using the application 135) can also provide additional services and features to the business user, such as real-time and direct employee scheduling. For example, the disclosed social network platform can provide an employee management system that allows a business and its employees to enter and manage employee work schedules (e.g., weekly/bi-weekly schedules); notify employees of scheduling changes or updates, or new schedules, through push notifications by the engine 110 to the individual employee users, e.g., pushed to their mobile devices and displayed on the user application 120; and to facilitate employee requests for shift changes or additional coverage, e.g., which can send such requests to other individual employee users, and send notice to the back end manager. For example, such requests can be managed through push notifications by the engine 110 sent to the other employees so they can select the time slot to cover. Also, for example, the employee management system can be implemented to notify back-end managers and request additional employees, in real-time, when significant increases in customers in the business (e.g., which can be based on the real-time postings of business promotions over the exemplary social media network) occurs and additional employees are needed to work. In some implementations, for example, the employee management system can be provided using the calendar tool of the application 135.

The exemplary business user back-end site 130 (e.g., using the application 135) can also provide additional services and features to the business and individual users, such as real-time and direct appointment alerts and notifications. For example, the back-end site 130 can be used to manage appointment dates for the business (e.g., which can be stored on the computer system 200, and/or on the computing device of the business user), and track if/how the individual user follows up on the appointments. For example, the engine 110 can automatically notify the individual customer users having a schedule appointment with a reminder and/or message through push notifications by the engine 110 to the individual users, e.g., pushed to their mobile devices and displayed on the user application 120. Similarly, the business users can use the back-end site 130 (e.g., via the application 135) to send messages associated with the appointments, e.g., such as “your reservation at 7:00 pm tonight is 20 minutes past, and we will give your table away in 10 minutes unless we hear from you.”

The exemplary business user back-end site 130 (e.g., using the application 135) can also provide additional services and features to the business and individual users, such as reservations for services or products provided by the business. For example, an exemplary reservation service of the disclosed social network platform allows users to easily make reservations via the user application 120 when they find a business (e.g., restaurant) they wish to patron and/or see a business on one of the user's connection's posts that entices the user to select that business. The exemplary reservation service allows the users who have made a reservation to track the time until their reservation and receive alerts on the status. Once the user arrives at the business, the business can confirm their arrival.

The exemplary reservation service provides the business users (e.g., restaurant owners) with a simplistic reservation system that is readily available for their followers to view, and for prospective consumers to easily find. The exemplary reservation service provided by the disclosed social network platform can replace or supplement the business’ existing current reservation systems. It provides the ERB as an integrated software and hardware solution that computerizes restaurant host-stand operations. For example, in some implementations of the exemplary reservation service, the back-end site 130 provides a reservations management tool displayed on the application 135 that can handle reservation management (e.g., table management), provide guest recognition and ratings, and add an important addition to the business' marketing repertoire.

For example, the exemplary reservation service can provide reservation management, e.g., creating, changing, canceling and/or confirming reservations by individual users for a business. For example, the exemplary reservation service can provide guest management services, e.g., such as keeping track of VIPs, customer preferences, customer ratings (e.g., likelihood of cancellations) and repeat customers. For example, the guest management services can also allow targeted marketing to customer users of the disclosed social media network. For example, the exemplary reservation service can provide table management to restaurant businesses, e.g., assisting restaurant staff in seating customers and tracking table status. For example, the exemplary reservation service can provide point of sale (POS) integration—connects to point of sale system/social network system payment network to retain check spend data by reservation and guest. For example, the exemplary POS integration feature of the reservation service can assist in taking orders and payment (e.g., such as taking payments through bypass interchange fees, which typically range between 4-7%). Also, for example, the exemplary reservation service can provide reports, e.g., advanced analytics to help sustain and improve the business' efficiency.

Exemplary Payment Methods

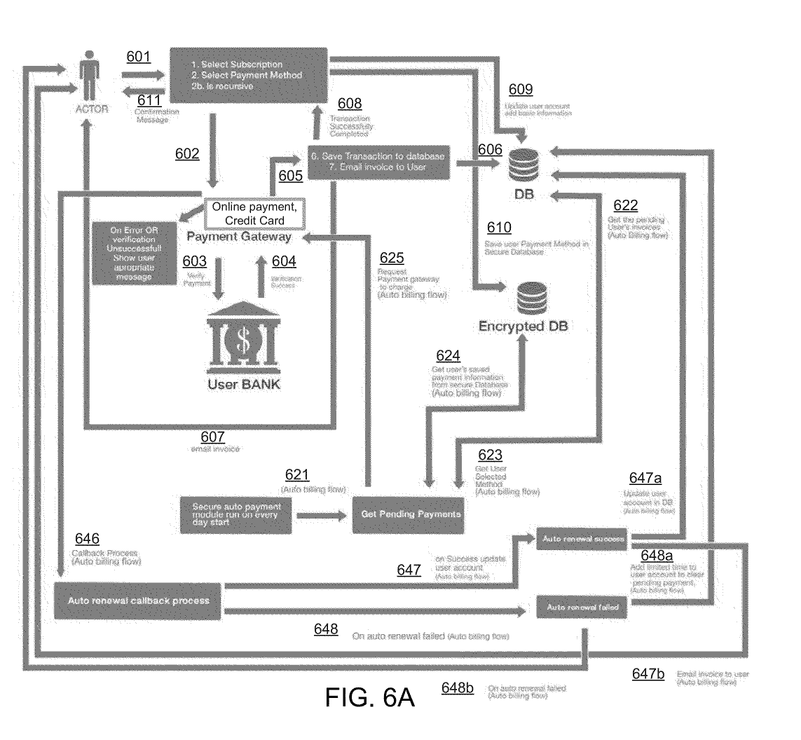

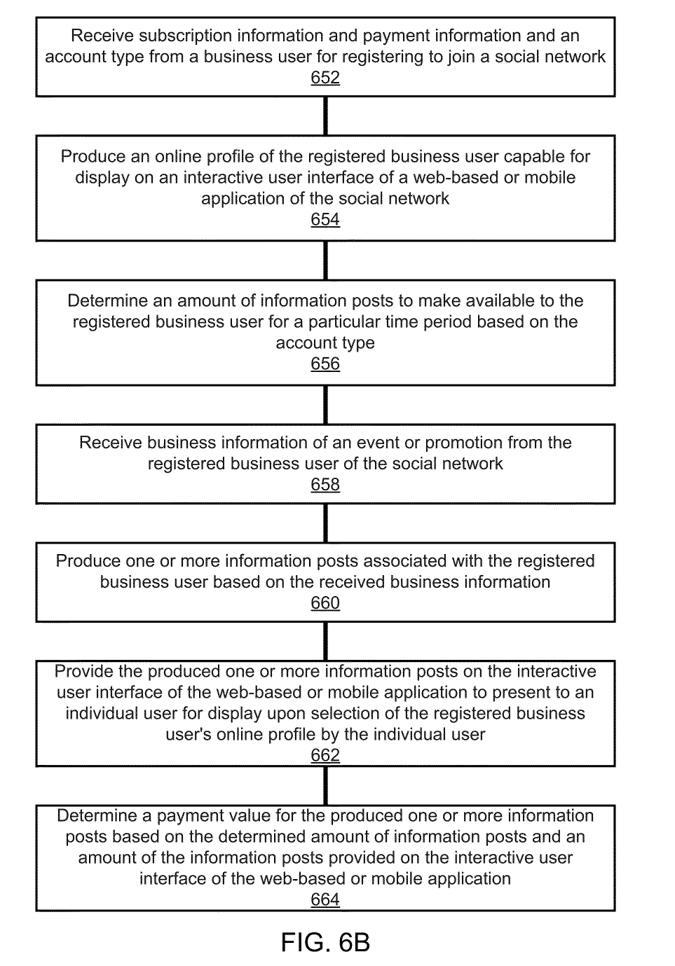

FIG. 6A shows a flow chart diagram of an exemplary payment method of the disclosed social network platform. As shown in the flow chart diagram of FIG. 6A, the social network management engine 110 can implement a process 601 to enable the actor (e.g., a business user of the social network) to select a subscription, select a payment method (e.g., online pay, credit card, etc.), and a select a recursive payment method. The engine 110 can implement a process 602 to receive payment at a payment gateway. The engine 110 can implement a process 603 to verify the payment was received by the payment gateway (e.g., from the exemplary business user's bank). For example, upon occurrence of an error OR verification unsuccessful, the engine 110 can provide the actor with an appropriate informational method of the error or unsuccessful verification. Upon successful verification, the engine 110 can implement a process 604 to report the verification of payment was received by the payment gateway. The engine 110 can implement a process 605 to save the transaction to a database of the computer system and produce an email or other reporting communication of an invoice to the actor. The engine 110 can implement a process 606 to verify the transaction information was saved to the database. The engine 110 can implement a process 607 to send the produced email or other reporting communication of the invoice to the actor. The engine 110 can implement a process 608 to determine that the transaction was successfully completed. The engine 110 can implement a process 609 to update the user account and/or add basic information in the database. The engine 110 can implement a process 606 to save the user payment method in a secure database (e.g., encrypted database) of the computer system. The engine 110 can implement a process 611 to provide a confirmation message to the actor.

Also, as shown in the flow chart diagram of FIG. 6A, the social network management engine 110 can implement a process 621 to secure an auto payment module of the engine 110 is run on a continuous temporal routine (e.g., such as an everyday start). For example, the implementation of the process 621 can begin an auto billing flow method. The engine 110 can implement a process 622 of the auto billing flow method to get pending payments, e.g., in which the engine 110 communicates with the database to obtain the pending user's invoices. The engine 110 can implement a process 623 of the auto billing flow method to obtain the user's selected method of payment. The engine 110 can implement a process 624 of the auto billing flow method to obtain the user's saved payment information from the secure database of the computer system. The engine 110 can implement a process 625 of the auto billing flow method to request the payment gateway to charge the user for an amount based on the acquired information, e.g., such as the user's pending invoice. The engine 110 can then implement the processes 602-605, as well as any of the processes 606-611.

Also, as shown in the flow chart diagram of FIG. 6A, the social network management engine 110 can implement a process 646 to perform an auto renewal callback process of the auto billing flow method. The engine 110 can implement a process 647 to determine success of the auto renewal process. The engine 110 can implement a process 648 to determine failure of the auto renewal process. Upon success, the engine 110 can implement a process 647a to update the user account in the database. Upon success, the engine 110 can implement a process 647b to report the invoice (e.g., email the invoice) to the user. Upon failure, the engine 110 can implement a process 648a to add limited time to the user account to clear pending payment, e.g., in the database. Also, upon failure, the engine 110 can implement a process 648b to report the failure to the user.

FIG. 6B shows a process diagram of an exemplary method for determining payment for online posts to users of a social network using the disclosed technology. The method includes a process 652 to receive, at a computer system of one or more computers, subscription information and payment information and an account type from a business user for registering to join a social network. The method includes a process 654 to produce, at the computer system, an online profile of the registered business user (e.g., host the online profile) capable for display on an interactive user interface of a web-based or mobile application of the social network. The method includes a process 656 to determine, at the computer system, an amount of information posts to make available to the registered business user for a particular time period based on the account type. The method includes a process 658 to receive, at the computer system, business information of an event or promotion from the registered business user of the social network. The method includes a process 660 to produce, at the computer system, one or more information posts associated with the registered business user based on the received business information. The method includes a process 662 to provide, by the computer system, the produced one or more information posts on the interactive user interface of the web-based or mobile application to present to an individual user for display upon selection of the registered business user's online profile by the individual user. The method includes a process 664 to determine, at the computer system, a payment value for the produced one or more information posts based on the determined amount of information posts and an amount of the information posts provided on the interactive user interface of the web-based or mobile application.

For example, the subscription information can include name, location, and contact information from the business user. For example, the payment information can include (i) a type of payment including credit card information or online payment account information, and (ii) a frequency of payment. For example, the frequency of payment can include a reoccurring charge on a daily, weekly, monthly, multi-monthly, annual, or other time basis. In some implementations of the method of FIG. 6B, for example, the method can further include a process to determine, at the computer system, a posting time of the one or more produced information posts to provide to individual users of the social network via a web-based or mobile application; and providing, by the computer system, the produced one or more information posts at or after the determined posting time on the interactive user interface of the web-based or mobile application to present to the individual user for display upon selection of the registered business user's online profile by the individual user.

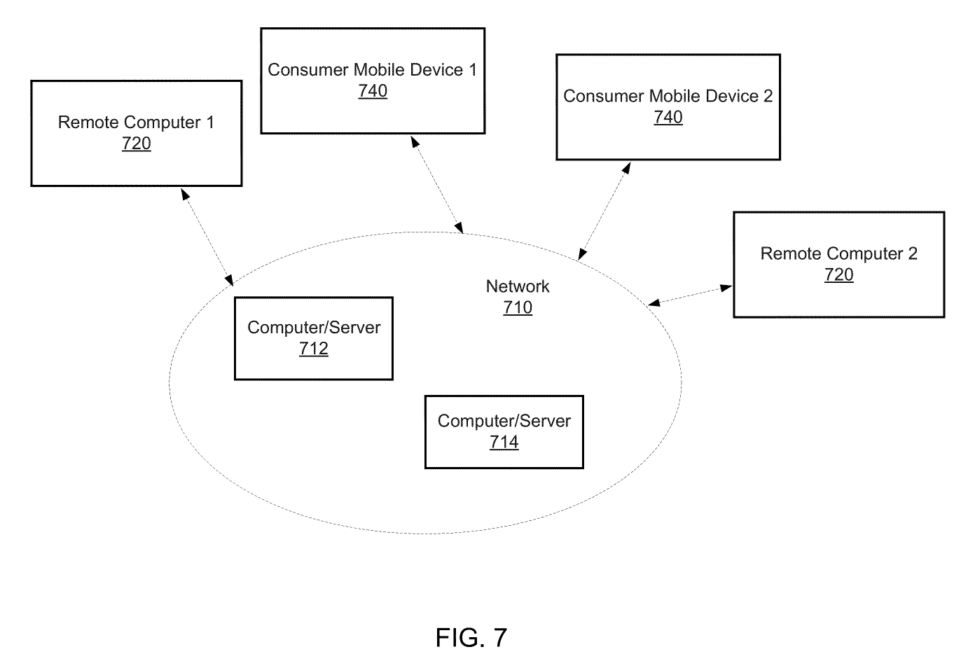

FIG. 7 shows an example of the communication network 710 that includes computer systems and devices for implementing the disclosed technology. The communication network 710 includes centralized computers or servers 712, 714 that are in communication with a plurality of remote computing devices operated by business users and by consumer users of a social network via a communication network or link. The remote computing devices can include remote computers 720 used by registered business users and/or consumers, and mobile devices 740 such as mobile phones, tablets and other mobile devices used by the registered business users and/or the consumers for implementing the disclosed online social network platform. The one or more computers or servers 712, 714 in the network 710 are configured to include software modules of the social network management engine 110 configured to process, store, and communicate data to facilitate the social network accessible to the business users and the consumer users. The computers or servers 712, 714 are capable to facilitate the exchange of data with the client computing devices 720, 740 to provide an interactive user interface operable on the client computing devices 720, 740, e.g., via a software application residing on the mobile devices 740 and/or a web portal on a web browser of the remote computers 720 and/or the mobile devices 740. In operation, for example, the remote computers 720, 740 can use the communication network 710 to remotely access the social network management engine 110 based on permissions associated with the type of user and the information to be exchanged between. The interactive user interface includes one interactive user interface designed for the consumer user clients using the computing devices 720, 740, and another interactive user interface designed for the business user clients on the computing devices 720, 740. For example, a mobile application of the disclosed social network platform can be installed on the mobile devices 740 of the consumer users to provide a consumer user version of the interactive user interface to present a graphic and/or textual representation of the registered businesses on a generated listing, e.g., allowing the consumer users to pull information generated by the registered business users (e.g., such as marketing information including advertisements and updates) in real time based on a search and/or the geolocation of the mobile devices 740.

For example, the computing devices 720, 740 can be operated by clients of the social network platform 100, including, e.g., the business users, the consumer users, and other types of users. For example, the consumer user clients can operate the computing devices 720, 740 to provide information associated with his/her location, user information (e.g., name, contact info, etc. to form a profile on the social network), preferences, messages and communications with other client users, and other types of information. For example, the consumer user clients can provide their location to the computers or servers 712, 714 based on the location information generated on their mobile device 740, and/or a preferred location by the user providing an address or identifying a location on an interactive map of the interactive user interface using the remote computers 720 or the mobile devices 740. The consumer user clients can operate the computing devices 720, 740 to receive information from the computers or servers 712, 714, e.g., including processed information and messages regarding the businesses of the social network, e.g., such as an ongoing or upcoming promotion or event, or information about what is currently going on with the business, and other types of information. For example, the business user clients can operate the computing devices 720, 740 to provide information associated the business (e.g., name, location info, etc. and events or promotions, and other types of information using a business user version of the interactive user interface on the mobile application or web portal of the web browser. The business user clients can operate the computing devices 720, 740 to receive information from the computers or servers 712, 714, e.g., including processed information and messages generated by the social network management engine 110 and information generated by the consumer users, and other types of information. In some implementations, for example, the computers or servers 712, 714 are configured to communicate to computers or servers that operate other social networks to integrate data from the social network into the social network platform 100.

### EXAMPLES

The following examples are illustrative of several embodiments of the present technology. Other exemplary embodiments of the present technology may be presented prior to the following listed examples, or after the following listed examples.

In one example of the present technology (example 1), a method to provide direct advertising in real-time includes receiving, at a computer system of one or more computers, advertisement information of an event or promotion from a business registered with a social network; producing, at the computer system, one or more current advertisements associated with the business based on the received advertisement information; receiving, at the computer system, location data from a mobile communications device of an individual user using a mobile application of the social network; analyzing, at the computer system, the received location data to determine a regional area of the individual user's location based on a range defined by the location data and a distance setting associated with the individual user; generating, at the computer system, a listing of businesses registered with the social network within the determined regional area; providing, by the computer system, an interactive user interface on the mobile application to present to the individual user at least one of a graphic or textual representation of the businesses on the generated listing; receiving, at the computer system, a request by the individual user for information of a selected business chosen by the individual user from the businesses presented on the interactive user interface; and providing, by the computer system, the produced one or more current advertisements associated with the selected business for display on the interactive user interface of the mobile application.

Example 2 includes the method as in example 1, in which the presented representation of the businesses on the listing includes one or more of name of the businesses, location information of the businesses, and business type of the businesses.

Example 3 includes the method as in example 1, further including receiving, at the computer system, subsequent advertisement information of another event or promotion from the business; and producing the one or more current advertisements associated with the business based on one or both of the received advertisement information and the subsequent advertisement information.

Example 4 includes the method as in example 1, in which the event or the promotion includes an ongoing or an upcoming event or promotion.

Example 5 includes the method as in example 1, in which the mobile communications device of the individual user includes at least one of a smartphone, a tablet, or a wearable communications device including a smart-watch or a smart-glasses.

Example 6 includes the method as in example 1, in which the distance setting associated with the individual user is determined by the individual user using the mobile application.

Example 7 includes the method as in example 6, in which the distance setting is stored by one or both of the mobile communications device and the computer system.

In one example of the present technology (example 8), a method for determining payment for online posts to users of a social network includes receiving, at a computer system of one or more computers, subscription information and payment information and an account type from a business user for registering to join a social network; producing, at the computer system, an online profile of the registered business user capable for display on an interactive user interface of a web-based or mobile application of the social network; determining, at the computer system, an amount of information posts to make available to the registered business user for a particular time period based on the account type; receiving, at the computer system, business information of an event or promotion from the registered business user of the social network; producing, at the computer system, one or more information posts associated with the registered business user based on the received business information; providing, by the computer system, the produced one or more information posts on the interactive user interface of the web-based or mobile application to present to an individual user for display upon selection of the registered business user's online profile by the individual user; and determining, at the computer system, a payment value for the produced one or more information posts based on the determined amount of information posts and an amount of the information posts provided on the interactive user interface of the web-based or mobile application.

Example 9 includes the method as in example 8, in which the subscription information includes name, location, and contact information from the business user.

Example 10 includes the method as in example 8, in which the payment information includes (i) a type of payment including credit card information or online payment account information, and (ii) a frequency of payment.

Example 11 includes the method as in example 10, in which the frequency of payment includes a monthly reoccurring charge.

Example 12 includes the method as in example 8, further including determining, at the computer system, a posting time of the one or more produced information posts to provide to individual users of the social network via a web-based or mobile application; and providing, by the computer system, the produced one or more information posts at or after the determined posting time on the interactive user interface of the web-based or mobile application to present to the individual user for display upon selection of the registered business user's online profile by the individual user.

In one example of the present technology (example 13), a system for providing an online social network platform includes a communication network including one or more computers in communication with a plurality of remote computing devices operated by business users and by consumer users of a social network via a communication network or link, in which the business users are users that operate a business and are registered to participate on the social network by a paid subscription, and consumer users are individual users registered participate on the social network without a paid subscription, in which the computing system is configured to process, store, and communicate data to facilitate the social network accessible to the business users and the consumer users by providing a first user interface on the remote computing devices of the consumer users and a second user interface on the remote computing devices of the business users.

Example 14 includes the system as in example 13, in which the computing system delivers information in real-time provided by a business user to selected consumer users based on an individual user's proximity to the business of the business user using location data of the individual user's remote computing device.

Example 15 includes the system as in example 14, in which the information includes an advertisement of an event or promotion of the business.

Example 16 includes the system as in example 15, in which the event or the promotion includes an ongoing event or promotion or an upcoming event or promotion.

Example 17 includes the system as in example 14, in which the information includes at least one of current capacity at the business, current wait times at the business, pricing of products or services of the business, a special or incentive of products or services of the business, or reviews of the business.

Example 18 includes the system as in example 14, in which the computing system delivers the information in real-time provided by the business user to the selected consumer when the selected consumer requests such information about the business from the social network.

Example 19 includes the system as in example 14, in which the computing system is configured to produce a calendar on the second user interface to allow the business users to schedule a time period for the computer system to deliver the information to the selected users.

Example 20 includes the system as in example 13, in which the remote computing devices include at least one of a desktop or laptop computer device, or a mobile communications device including a smartphone, tablet, or wearable communications device.

Example 21 includes the system as in example 13, in which the computer system is configured to enable the consumer users to post information about a business user of the social network or about themselves to another social network.

Example 22 includes the system as in example 13, in which the computer system is configured to integrate data from another social network into the social network.

Example 23 includes the system as in example 13, including mobile computing devices used by consumer users in communication with the communication network and installed with a mobile app that supports the first user interface to allow consumer users to select and rate a business of business users and to pass on the selected business information to consumer user social network friends.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method to provide direct advertising in real-time, comprising:
receiving, at a computer system of one or more computers, advertisement information of an event or promotion from a business registered with a social network;
producing, at the computer system, one or more current advertisements associated with the business based on the received advertisement information;
receiving, at the computer system, location data from a mobile communications device of an individual user using a mobile application of the social network;
analyzing, at the computer system, the received location data to determine a regional area of the individual user's location based on a range defined by the location data and a distance setting associated with the individual user;
generating, at the computer system, a listing of businesses registered with the social network within the determined regional area;
providing, by the computer system, an interactive user interface on the mobile application to present to the individual user at least one of a graphic or textual representation of the businesses on the generated listing;
receiving, at the computer system, a request by the individual user for information of a selected business chosen by the individual user from the businesses presented on the interactive user interface; and
providing, by the computer system, the produced one or more current advertisements associated with the selected business for display on the interactive user interface of the mobile application.

2. The method as in claim 1, wherein the presented representation of the businesses on the listing includes one or more of name of the businesses, location information of the businesses, and business type of the businesses.

3. The method as in claim 1, further comprising:
receiving, at the computer system, subsequent advertisement information of another event or promotion from the business; and
producing the one or more current advertisements associated with the business based on one or both of the received advertisement information and the subsequent advertisement information.

4. The method as in claim 1, wherein the event or the promotion includes an ongoing or an upcoming event or promotion.

5. The method as in claim 1, wherein the mobile communications device of the individual user includes at least one of a smartphone, a tablet, or a wearable communications device including a smart-watch or a smart-glasses.

6. The method as in claim 1, wherein the distance setting associated with the individual user is determined by the individual user using the mobile application.

7. The method as in claim 6, wherein the distance setting is stored by one or both of the mobile communications device and the computer system.

8. A method for determining payment for online posts to users of a social network, comprising:
receiving, at a computer system of one or more computers, subscription information and payment information and an account type from a business user for registering to join a social network;
producing, at the computer system, an online profile of the registered business user capable for display on an interactive user interface of a web-based or mobile application of the social network;
determining, at the computer system, an amount of information posts to make available to the registered business user for a particular time period based on the account type;
receiving, at the computer system, business information of an event or promotion from the registered business user of the social network;
producing, at the computer system, one or more information posts associated with the registered business user based on the received business information;
providing, by the computer system, the produced one or more information posts on the interactive user interface of the web-based or mobile application to present to an individual user for display upon selection of the registered business user's online profile by the individual user; and
determining, at the computer system, a payment value for the produced one or more information posts based on the determined amount of information posts and an amount of the information posts provided on the interactive user interface of the web-based or mobile application.

9. The method as in claim 8, wherein the subscription information includes name, location, and contact information from the business user.

10. The method as in claim 8, wherein the payment information includes (i) a type of payment including credit card information or online payment account information, and (ii) a frequency of payment.

11. The method as in claim 10, wherein the frequency of payment includes a monthly reoccurring charge.

12. The method as in claim 8, further comprising:
determining, at the computer system, a posting time of the one or more produced information posts to provide to individual users of the social network via a web-based or mobile application; and
providing, by the computer system, the produced one or more information posts at or after the determined posting time on the interactive user interface of the web-based or mobile application to present to the individual user for display upon selection of the registered business user's online profile by the individual user.

13. A system for providing an online social network platform, comprising:
a communication network including one or more computers in communication with a plurality of remote computing devices operated by business users and by consumer users of a social network via a communication network or link,
wherein the business users are users that operate a business and are registered to participate on the social network by a paid subscription, and consumer users are individual users registered participate on the social network without a paid subscription,
wherein the computing system is configured to process, store, and communicate data to facilitate the social network accessible to the business users and the consumer users by providing a first user interface on the remote computing devices of the consumer users and a second user interface on the remote computing devices of the business users.

14. The system as in claim 13, wherein the computing system delivers information in real-time provided by a business user to selected consumer users based on an individual user's proximity to the business of the business user using location data of the individual user's remote computing device.

15. The system as in claim 14, wherein the information includes an advertisement of an event or promotion of the business.

16. The system as in claim 15, wherein the event or the promotion includes an ongoing event or promotion or an upcoming event or promotion.

17. The system as in claim 14, wherein the information includes at least one of current capacity at the business, current wait times at the business, pricing of products or services of the business, a special or incentive of products or services of the business, or reviews of the business.

18. The system as in claim 14, wherein the computing system delivers the information in real-time provided by the business user to the selected consumer when the selected consumer requests such information about the business from the social network.

19. The system as in claim 14, wherein the computing system is configured to produce a calendar on the second user interface to allow the business users to schedule a time period for the computer system to deliver the information to the selected users.

20. The system as in claim 13, wherein the remote computing devices include at least one of a desktop or laptop computer device, or a mobile communications device including a smartphone, tablet, or wearable communications device.

21. The system as in claim 13, wherein the computer system is configured to enable the consumer users to post information about a business user of the social network or about themselves to another social network.

22. The system as in claim 13, wherein the computer system is configured to integrate data from another social network into the social network.

23. The system as in claim 13, comprising:
mobile computing devices used by consumer users in communication with the communication network and installed with a mobile app that supports the first user interface to allow consumer users to select and rate a business of business users and to pass on the selected business information to consumer user social network friends.
